(19) United States
(12) Patent Application Publication
(10) Pub. No.: US 2025/0313200 A1
(43) Pub. Date: Oct. 9, 2025

(54) DRIVE UNIT AND TRANSMISSION DEVICE

(71) Applicant: EXEDY Corporation, Osaka (JP)

(72) Inventor: Yoshihiro MATSUOKA, Osaka (JP)

(21) Appl. No.: 19/094,840

(22) Filed: Mar. 29, 2025

(30) Foreign Application Priority Data
Apr. 8, 2024 (JP) 2024-062155

(51) Int. Cl. B60W 30/14; B60W 10/08; B60W 10/10

(52) U.S. Cl. CPC B60W 30/143; B60W 10/08; B60W 10/10

(57) ABSTRACT

A drive unit includes an electric motor, a planetary gear mechanism, an input member, an output member, a first clutch, a stationary member, a second clutch, and a first urging member. The planetary gear mechanism includes a sun gear, a planet gear, a ring gear, and a planet carrier. The input member couples the electric motor and either the ring gear or the sun gear to each other. The output member is coupled to the planet carrier. The first clutch selectively couples/decouples the input member and the output member. The second clutch selectively couples/decouples the stationary member and the other of the ring gear and the sun gear. The first urging member urges the second clutch to turn the second clutch to an engaged state.

### CROSS-REFERENCE TO RELATED APPLICATIONS

This application is based on and claims the priority benefit of application No. 2024-062155 filed on Apr. 8, 2024, the contents of which are incorporated herein by reference.

### TECHNICAL FIELD

The claimed invention relates to a drive unit and a transmission device.

### BACKGROUND

A transmission device described in Japan Laid-open Patent Application Publication No. H09-210149 is configured to transmit a mechanical power from an internal combustion engine to a drive wheel, while the mechanical power is changed in rotational speed. Specifically, the transmission device includes a first clutch, a second clutch, and a planetary gear mechanism. The transmission device is switched in gear ratio by switching the states of the first and second clutches by hydraulic pressure.

### SUMMARY OF THE CLAIMED INVENTION

When employing the transmission device configured as described above, a drive unit including an electric motor as a drive source is supposed to reduce energy consumption. In view of this, it is an object of the claimed invention to reduce energy consumption.

A drive unit according to a first aspect includes an electric motor, a planetary gear mechanism, an input member, an output member, a first clutch, a stationary member, a second clutch, and a first urging member. The planetary gear mechanism includes a sun gear, a planet gear, a ring gear, and a planet carrier. The input member couples the electric motor and one of the ring gear and the sun gear therethrough to each other. The output member is coupled to the planet carrier. The first clutch couples the input member and the output member therethrough to each other in a manner capable of decoupling the input member and the output member therethrough from each other. The stationary member is disposed to be non-rotatable. The second clutch couples the stationary member and the other of the ring gear and the sun gear therethrough to each other in a manner capable of decoupling the stationary member and the other of the ring gear and the sun gear therethrough from each other. The first urging member urges the second clutch to turn the second clutch to an engaged state.

According to this configuration, the second clutch is turned to the engaged state by the first urging member. In other words, a hydraulic pressure is not required to turn the second clutch to the engaged state in traveling at a low speed; hence, it is made possible to reduce energy consumption.

A drive unit according to a second aspect relates to the drive unit according to the first aspect and further includes a one-way clutch. The one-way clutch allows the other of the ring gear and the sun gear to rotate in a forward moving rotational direction.

A drive unit according to a third aspect relates to the drive unit according to the first or second aspect and further includes a second urging member. The second urging member urges the first clutch to turn the first clutch to a disengaged state.

A drive unit according to a fourth aspect relates to the drive unit according to any of the first to third aspects and is configured as follows. The first clutch is a centrifugal clutch.

A drive unit according to a fifth aspect relates to the drive unit according to the fourth aspect and is configured as follows. The input member is disposed radially outside the output member. The first clutch includes a centrifugal element and an engaged groove. The centrifugal element is rotated unitarily with the output member. The centrifugal element is disposed to be radially movable with respect to the output member. The engaged groove is provided on an inner peripheral surface of the input member. The engaged groove is configured to be engaged with the centrifugal element.

A drive unit according to a sixth aspect relates to the drive unit according to the fifth aspect and is configured as follows. The first clutch further includes a magnet. The magnet is disposed radially inside the centrifugal element and attracts the centrifugal element by a magnetic force.

A drive unit according to a seventh aspect relates to the drive unit according to the fifth or sixth aspect and is configured as follows. The engaged groove includes a pair of inner wall surfaces circumferentially opposed to each other. At least one of the pair of inner wall surfaces slants radially inward to gradually separate from the other of the pair of inner wall surfaces.

A drive unit according to an eighth aspect relates to the drive unit according to any of the first to seventh aspects and is configured as follows. The input member includes a first input portion, a second input portion, and an elastic member elastically coupling the first input portion and the second input portion therethrough to each other.

A drive unit according to a ninth aspect relates to the drive unit according to any of the first to eighth aspects and further includes a controller. The controller executes a low-speed forward traveling mode, a high-speed forward traveling mode, and a rearward traveling mode. The controller rotates the electric motor to rotate in a forward moving rotational direction, turns the first clutch to a disengaged state, and turns the second clutch to the engaged state when executing the low-speed forward traveling mode. The controller rotates the electric motor to rotate in the forward moving rotational direction, turns the first clutch to the engaged state, and turns the second clutch to the disengaged state when executing the high-speed forward traveling mode. The controller rotates the electric motor to rotate in a rearward moving rotational direction, turns the first clutch to the disengaged state, and turns the second clutch to the engaged state when executing the rearward traveling mode.

A drive unit according to a tenth aspect relates to the drive unit according to the ninth aspect and is configured as follows. The controller is configured to turn the second clutch to the disengaged state and thereafter turns the first clutch to the engaged state in switching from the low-speed forward traveling mode to the high-speed forward traveling mode.

A transmission device according to an eleventh aspect is configured to change a rotational speed of a mechanical power transmitted thereto from an electric motor. The transmission device includes a planetary gear mechanism, an input member, an output member, a first clutch, a stationary member, a second clutch, and a first urging member. The planetary gear mechanism includes a sun gear, a planet gear, a ring gear, and a planet carrier. The input member couples the electric motor and one of the ring gear and the sun gear therethrough to each other. The output member is coupled to the planet carrier. The first clutch couples the input member and the output member therethrough to each other in a manner capable of decoupling the input member and the output member therethrough from each other. The stationary member is disposed to be non-rotatable. The second clutch couples the stationary member and the other of the ring gear and the sun gear therethrough to each other in a manner capable of decoupling the stationary member and the other of the ring gear and the sun gear therethrough from each other. The first urging member urges the second clutch to turn the second clutch to an engaged state.

Overall, according to the claimed invention, it is made possible to reduce energy consumption.

### BRIEF DESCRIPTION OF THE DRAWINGS

FIG. 1 is a block diagram illustrating a drive unit.

FIG. 2 is a schematic diagram illustrating a transmission device.

FIG. 3 is a schematic front view of a planetary gear mechanism.

FIG. 4 is a flowchart showing a method of controlling by a controller.

FIG. 5 is a schematic diagram illustrating a transmission device according to a modification.

FIG. 6 is a schematic diagram illustrating a transmission device according to another modification.

FIG. 7 is an enlarged view of a portion of a first clutch (set in a disengaged state) according to the aforementioned another modification.

FIG. 8 is an enlarged view of the portion of the first clutch (set in an engaged state) according to the aforementioned another modification.

FIG. 9 is a schematic diagram illustrating a transmission device according to yet another modification.

### DETAILED DESCRIPTION

An embodiment of a drive unit 100 in accordance with the claimed invention will be hereinafter explained with reference to drawings. It should be noted that in the following explanation, the term “axial direction” refers to an extending direction of a rotational axis O of a transmission device 4. On the other hand, the term “circumferential direction” refers to a circumferential direction of an imaginary circle about the rotational axis O, whereas the term “radial direction” refers to a radial direction of the imaginary circle about the rotational axis O. Yet on the other hand, the term “forward moving rotational direction” refers to a direction in which a member for transmitting a torque (an electric motor 2, the transmission device 4, etc.) is rotated when a vehicle, in which the drive unit 100 is installed, is moved forward, whereas the term “rearward moving rotational direction” refers to a direction in which the member for transmitting the torque is rotated when the vehicle is moved rearward.

### Drive Unit

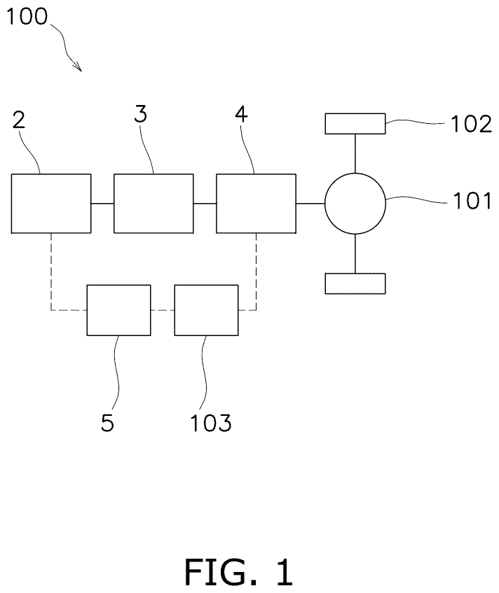

As shown in FIG. 1, the drive unit 100 includes the electric motor 2, a reducer 3, the transmission device 4, and a controller 5. A torque, outputted from the drive unit 100, is transmitted to a drive wheel 102 via a differential gear 101. The drive unit 100 may be installed, for instance, in an electric car. It should be noted that the drive unit 100 might not include the reducer 3.

### Electric Motor

The electric motor 2 is configured to be rotated in both the forward moving rotational direction and the rearward moving rotational direction. When the vehicle is moved forward, the electric motor 2 is rotated in the forward moving rotational direction. On the other hand, when the vehicle is moved rearward, the electric motor 2 is rotated in the rearward moving rotational direction.

### Reducer

The reducer 3 is disposed between the electric motor 2 and the transmission device 4 in a torque transmission path. The reducer 3 is configured to output a mechanical power, outputted thereto from electric motor 2, to the transmission device 4, while the mechanical power is reduced in rotational speed. The reducer 3 includes, for instance, a plurality of gears (omitted in illustration).

### Transmission Device

The transmission device 4 is configured to output the mechanical power, transmitted thereto from the electric motor 2, to the drive wheel 102 side, while the mechanical power is changed in rotational speed. The transmission device 4 is configured to change a gear ratio in a stepwise manner. It should be noted that in the presently preferred embodiment, the transmission device 4 is configured to change the gear ratio in two stages.

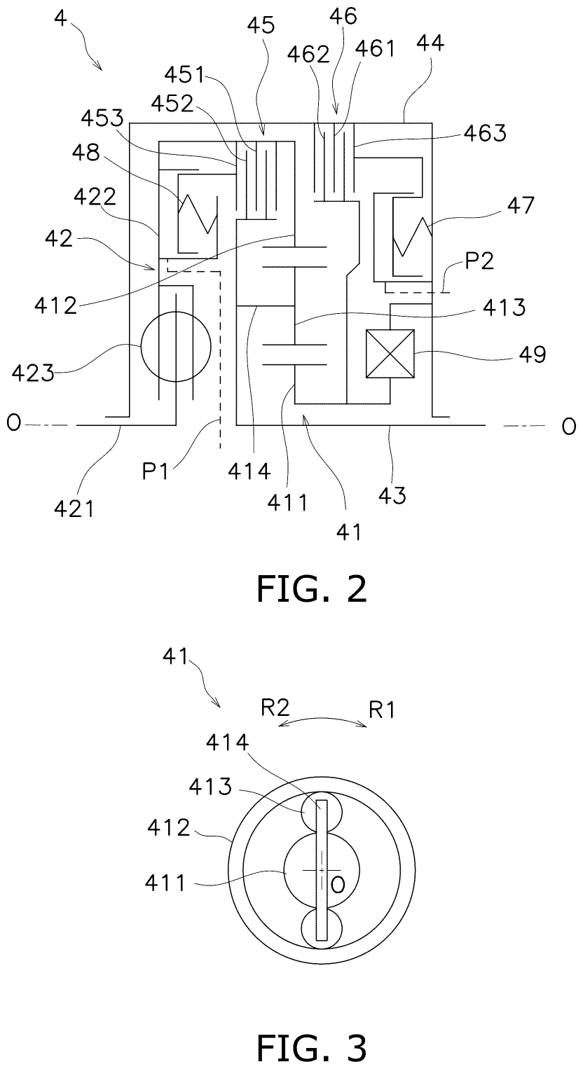

As illustrated schematically in FIG. 2, the transmission device 4 includes a planetary gear mechanism 41, an input member 42, an output member 43, a stationary housing 44 (exemplary stationary member), a first clutch 45, a second clutch 46, a first urging member 47, a second urging member 48, and a one-way clutch 49.

### Planetary Gear Mechanism

FIG. 3 is a front view of the planetary gear mechanism 41. As shown in FIG. 3, the planetary gear mechanism 41 includes a sun gear 411, a ring gear 412, a plurality of planet gears 413, and a planet carrier 414. The sun gear 411 is rotatable about the rotational axis O. The ring gear 412 has an annular shape. The ring gear 412 is an internal gear. The ring gear 412 encloses the sun gear 411. The ring gear 412 is rotatable about the rotational axis O.

The planet gears 413 are disposed radially between the sun gear 411 and the ring gear 412. Each planet gear 413 is meshed with the sun gear 411 and the ring gear 412. Each planet gear 413 revolves about the rotational axis O. Additionally, each planet gear 413 is rotatable about the rotational axis thereof. The planet carrier 414 is attached to the planet gears 413. The planet carrier 414 is rotatable about the rotational axis O.

### Input Member

As illustrated schematically in FIG. 2, the input member 42 couples the electric motor 2 and the ring gear 412 therethrough to each other. When described in detail, the input member 42 couples the reducer 3 and the ring gear 412 therethrough to each other. The input member 42 is rotated unitarily with the ring gear 412. The input member 42 receives a torque transmitted thereto from the electric motor 2. Additionally, the input member 42 transmits the torque to the ring gear 412.

The input member 42 includes a first input portion 421, a second input portion 422, and a plurality of elastic members 423. The first input portion 421 receives the torque transmitted thereto from the electric motor 2. The second input portion 422 transmits the torque to the ring gear 412.

The elastic members 423 elastically couple the first input portion 421 and the second input portion 422 therethrough to each other. In other words, torque transmission is made between the first and second input portions 421 and 422 through the elastic members 423.

### Output Member

The output member 43 is coupled to the planet carrier 414. The output member 43 is rotated unitarily with the planet carrier 414. The output member 43 rotates about the rotational axis O. The output member 43 penetrates the sun gear 411 to extend in the axial direction.

The output member 43 receives the torque from the planetary gear mechanism 41 and transmits the received torque to the drive wheel 102 side. When described in detail, the output member 43 transmits the torque to the differential gear 101.

The stationary housing 44 is non-rotatable. The stationary housing 44 is fixed to a vehicle frame or so forth. The stationary housing 44 accommodates the planetary gear mechanism 41, the first clutch 45, the second clutch 46, the first urging member 47, the second urging member 48, and the one-way clutch 49.

### First Clutch

The first clutch 45 couples the input member 42 and the output member 43 therethrough to each other in a manner that decouples the input member 42 and the output member 43 therethrough from each other. The first clutch 45 selectively couples the input member 42 and the output member 43 therethrough to each other (this state will be hereinafter referred to as “an engaged state”) and decouples the input member 42 and the output member 43 therethrough from each other (this state will be hereinafter referred to as “a disengaged state”). It should be noted that the first clutch 45 may be of a normally opened type. In other words, the first clutch 45 is turned to the disengaged state in a neutral condition without application of hydraulic pressure.

When the first clutch 45 is turned to the engaged state, the input member 42 and the output member 43 are coupled to each other and are rotated unitarily with each other. On the other hand, when the first clutch 45 is turned to the disengaged state, the input member 42 and the output member 43 are decoupled from each other and are able to rotate relative to each other.

The first clutch 45 includes a plurality of first clutch discs 451, a plurality of second clutch discs 452, and a first piston 453. The first clutch discs 451 and the second clutch discs 452 are alternately disposed in the axial direction. Each adjacent pair of first and second clutch discs 451 and 452 interposes a friction material therebetween. The friction material may be attached to either of each adjacent pair of first and second clutch discs 451 and 452.

The first clutch discs 451 are attached to the input member 42, while being movable in the axial direction. Additionally, the first clutch discs 451 are rotated unitarily with the input member 42. The second clutch discs 452 are attached to the output member 43, while being movable in the axial direction. The second clutch discs 452 are rotated unitarily with the output member 43.

The first piston 453 presses the first clutch discs 451 and the second clutch discs 452 such that the first clutch discs 451 and the second clutch discs 452 are engaged by friction with each other.

### Second Clutch

The second clutch 46 couples the sun gear 411 and the stationary housing 44 therethrough to each other in a manner that of decouples the sun gear 411 and the stationary housing 44 therethrough from each other. The second clutch 46 couples the sun gear 411 and the stationary housing 44 therethrough to each other (this state will be hereinafter referred to as “a coupling state”) and decouples the sun gear 411 and the stationary housing 44 therethrough from each other (this state will be hereinafter referred to as “a disengaged state”). It should be noted that the second clutch 46 may be of a normally closed type. In other words, the second clutch 46 is turned to the engaged state in the neutral condition without application of the hydraulic pressure.

When the second clutch 46 is turned to the engaged state, the sun gear 411 is coupled to the stationary housing 44 and is thereby made non-rotatable. On the other hand, when the second clutch 46 is turned to the disengaged state, the sun gear 411 is decoupled from the stationary housing 44 and is thereby able to rotate.

The second clutch 46 includes a plurality of third clutch discs 461, a plurality of fourth clutch discs 462, and a second piston 463. The third clutch discs 461 and the fourth clutch discs 462 are alternately disposed in the axial direction. Each adjacent pair of third and fourth clutch discs 461 and 462 interposes a friction material therebetween. The friction material may be attached to either of each adjacent pair of third and fourth clutch discs 461 and 462.

The third clutch discs 461 are attached to the stationary housing 44, while being movable in the axial direction. The third clutch discs 461 are non-rotatable. The fourth clutch discs 462 are attached to the sun gear 411, while being movable in the axial direction. The fourth clutch discs 462 are rotated unitarily with the sun gear 411.

The second piston 463 presses the third clutch discs 461 and the fourth clutch discs 462 such that the third clutch discs 461 and the fourth clutch discs 462 are engaged by friction with each other.

### First Urging Member

The first urging member 47 urges the second clutch 46 to turn the second clutch 46 to the engaged state. The first urging member 47 may, for instance, be a coil spring. The first urging member 47 is disposed in a compressed state. The first urging member 47 presses the second piston 463 axially toward the third clutch discs 461 and the fourth clutch discs 462. It should be noted that the second clutch 46 is turned to the disengaged state when the second piston 463 is axially moved against the urging force of the first urging member 47 by the hydraulic pressure.

### Second Urging Member

The second urging member 48 urges the first clutch 45 to turn the first clutch 45 to the disengaged state. The second urging member 48 may, for instance, be a coil spring. The second urging member 48 axially presses the first piston 453 to separate the first piston 453 from the first clutch discs 451 and the second clutch discs 452. It should be noted that the first clutch 45 is turned to the engaged state when the first piston 453 is axially moved against the urging force of the second urging member 48 by the hydraulic pressure.

### One-way Clutch

The one-way clutch 49 is configured to allow the sun gear 411 to rotate in the forward moving rotational direction (see arrow R1 in FIG. 3). It should be noted that the one-way clutch 49 prevents the sun gear 411 from rotating in the rearward moving rotational direction (see arrow R2 in FIG. 3). Specifically, the one-way clutch 49 includes an inner race, an outer race, and a set of sprags. One of the inner and outer races is fixed to the sun gear 411, while the other is fixed to the stationary housing 44. When the sun gear 411 is going to be rotated in the rearward moving rotational direction R2, the sprags jam between the inner and outer races, whereby a torque is transmitted between the inner and outer races. As a result, the one-way clutch 49 is made non-rotatable and prevents the sun gear 411 from rotating in the rearward moving rotational direction R2. On the other hand, when the sun gear 411 is rotated in the forward moving rotational direction R1, the sprags are released from jamming, whereby the inner and outer races freely rotate relative to each other. As a result, the sun gear 411 is able to be rotated in the forward moving rotational direction R1.

### Controller

As shown in FIGS. 1 and 2, the controller 5 is configured to control the electric motor 2, the first clutch 45, and the second clutch 46. Specifically, the controller 5 controls a hydraulic unit 103 to control the first and second clutches 45 and 46. The hydraulic unit 103 includes, for instance, a hydraulic pump, a control valve, and so forth. The hydraulic unit 103 supplies the first clutch 45 with the hydraulic pressure via a first oil pathway P1, while supplying the second clutch 46 with the hydraulic pressure via a second oil pathway P2.

For example, a computer (e.g., microcomputer), including a CPU (Central Processing Unit), a ROM (Read Only Memory), and so forth, is provided as the controller 5. The ROM has stored programs for executing a variety of computations. The CPU executes the programs stored in the ROM.

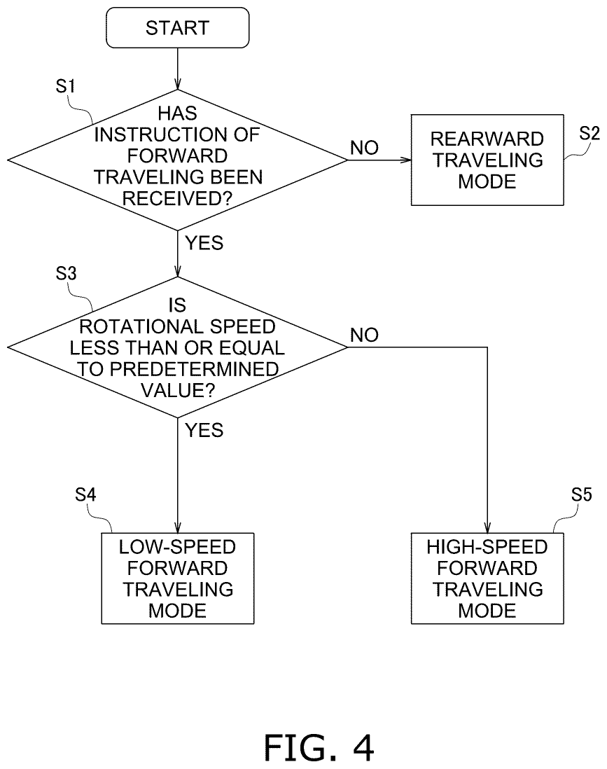

The controller 5 executes a low-speed forward traveling mode, a high-speed forward traveling mode, and a rearward traveling mode. For example, as shown in FIG. 4, the controller 5 determines whether or not an instruction of forward traveling has been received from a driver (step S1). When it is determined that the instruction of forward traveling has not been received, i.e., that an instruction of rearward traveling has been received (No in step S1), the controller 5 executes the rearward traveling mode (step S2).

On the other hand, when it is determined that the instruction of forward traveling has been received (Yes in Step S1), the controller 5 next determines whether or not the rotational speed of the output member 43 is less than or equal to a predetermined value (Step S3). When it is determined that the rotational speed of the output member 43 is less than or equal to the predetermined value (Yes in step S3), the controller 5 executes the low-speed forward traveling mode (step S4). When it is determined that the rotational speed of the output member 43 is not less than or equal to the predetermined value, in other words, that the rotational speed of the output member 43 is greater than the predetermined value (No in step S3), the controller 5 executes the high-speed forward traveling mode (step S5).

When executing the low-speed forward traveling mode, the controller 5 causes the electric motor 2 to rotate in the forward moving rotational direction. Then, the controller 5 turns the first clutch 45 to the disengaged state, while turning the second clutch 46 to the engaged state. It should be noted that the first clutch 45 is disengaged without the hydraulic pressure being applied to it; hence, the controller 5 controls the hydraulic unit 103 to stop supplying the first clutch 45 with the hydraulic pressure. On the other hand, the second clutch 46 is engaged without the hydraulic pressure being applied to it; hence, the controller 5 controls the hydraulic unit 103 to stop supplying the second clutch 46 with the hydraulic pressure. Thus, it is not required to actuate the hydraulic unit 103 in the low-speed forward traveling mode; hence, energy consumption can be reduced.

The first clutch 45 is in the disengaged state in the low-speed forward traveling mode; hence, as shown in FIG. 3, the ring gear 412 and the planet carrier 414 are rotated in the forward moving rotational direction R1 (clockwise in FIG. 3), while being rotatable relative to each other. By contrast, the second clutch 46 is in the engaged state, while the sprags jam in the one-way clutch 49; hence, the sun gear 411 is made non-rotatable in the rearward moving rotational direction R2 (counterclockwise in FIG. 3) and is thereby kept in a standstill.

Based on the above, the planetary gear mechanism 41 transmits the torque, inputted thereto from the input member 42, to the output member 43, while the torque is amplified in magnitude by the planetary gear mechanism 41. Additionally, the planetary gear mechanism 41 transmits the mechanical power, inputted thereto from the input member 42, to the output member 43, while the mechanical power is reduced in rotational speed in the planetary gear mechanism 41.

When executing the high-speed forward traveling mode, the controller 5 causes the electric motor 2 to rotate in the forward moving rotational direction. Then, the controller 5 turns the first clutch 45 to the engaged state, while turning the second clutch 46 to the disengaged state. When described in detail, the controller 5 controls the hydraulic unit 103 to supply each of the first and second clutches 45 and 46 with the hydraulic pressure, whereby the first clutch 45 is turned to the engaged state, while the second clutch 46 is turned to the disengaged state.

The first clutch 45 is in the engaged state in the high-speed forward traveling mode; hence, the ring gear 412 and the planet carrier 414 are rotated unitarily with each other in the forward moving rotational direction R1. In contrast, the second clutch 46 is in the disengaged state, while the one-way clutch 49 is made freely rotatable; hence, the sun gear 411 is rotated in the forward moving rotational direction R1.

Based on the above, the planetary gear mechanism 41 transmits the mechanical power, inputted thereto from the input member 42, to the output member 43, while the mechanical power is not reduced in rotational speed. It should be noted that, in switching from the low-speed forward traveling mode to the high-speed forward traveling mode, the controller 5 first turns the second clutch 46 to the disengaged state such that the engaged state is made only in the one-way clutch 49, and then turns the first clutch 45 to the engaged state. With the control, the sun gear 411 is automatically and appropriately switched from the rotation locked state (standstill) to the rotation unlocked state (rotation in the forward moving rotational direction R1) by the one-way clutch 49; hence, gear shifting can be smoothly made without causing gear shifting shocks.

When executing the rearward traveling mode, the controller 5 causes the electric motor 2 to rotate in the rearward moving rotational direction. Then, the controller 5 turns the first clutch 45 to the disengaged state, while turning the second clutch 46 to the engaged state. Thus, it is not required to actuate the hydraulic unit 103 in the rearward traveling mode; hence, energy consumption can be reduced.

The first clutch 45 is in the disengaged state in the rearward traveling mode; hence, the ring gear 412 and the planet carrier 414 are rotated in the rearward moving rotational direction R2, while being rotatable relative to each other. The one-way clutch 49 is made freely rotatable in the rearward traveling mode; hence, the one-way clutch 49 cannot prevent the sun gear 411 from rotating in the forward moving rotational direction R1. However, the second clutch 46 is in the engaged state: hence, the sun gear 411 is made non-rotatable in the forward moving rotational direction R1 and is thereby kept in a standstill.

Based on the above, the planetary gear mechanism 41 transmits the torque, inputted thereto from the input member 42, to the output member 43, while the torque is amplified in magnitude in the planetary gear mechanism 41. Additionally, the planetary gear mechanism 41 transmits the mechanical power, inputted thereto from the input member 42, to the output member 43, while the mechanical power is reduced in rotational speed in the planetary gear mechanism 41.

### Modifications

One presently preferred embodiment of the claimed invention has been explained above. However, the claimed invention is not limited to the above, and a variety of changes can be made without departing from the scope of the claimed invention. It should be noted that basically speaking, respective modifications to be described are applicable simultaneously.

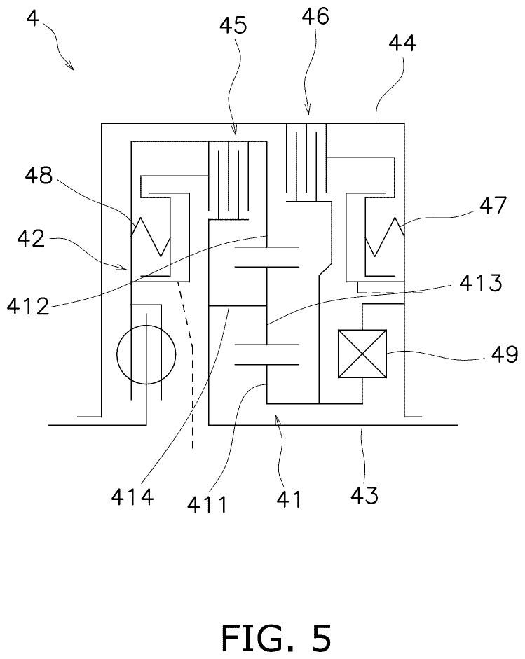

(a) As shown in FIG. 5, the first clutch 45 may be of a normally closed type. In other words, the second urging member 48 may urge the first clutch 45 to turn the first clutch 45 to the engaged state.

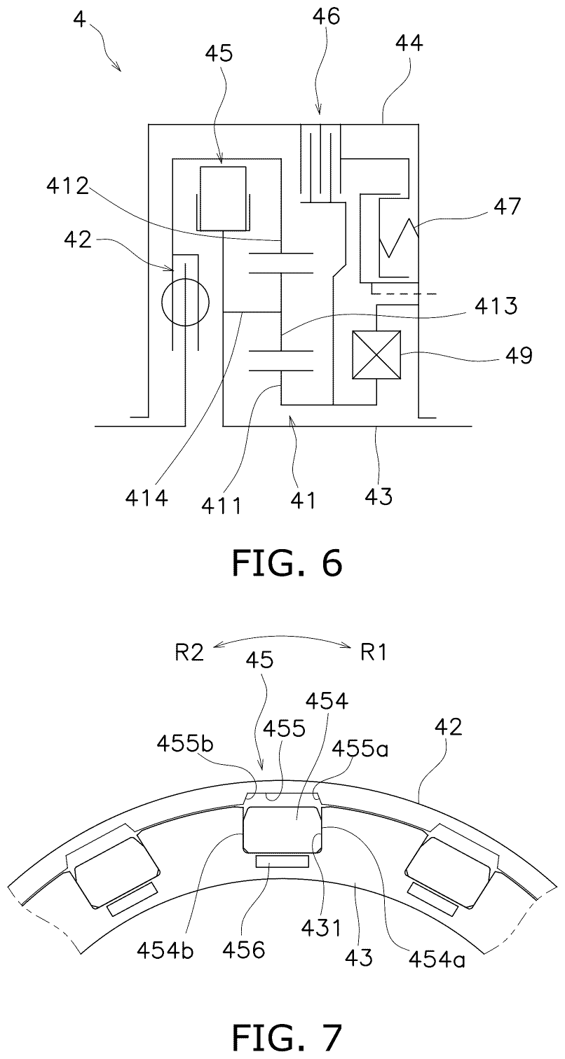

(b) As shown in FIG. 6, the first clutch 45 may be a centrifugal clutch. In other words, the first clutch 45 may be configured to engage the input member 42 and the output member 43 therethrough with each other, when centrifugal forces due to rotation of the output member 43 are applied to it. In this case, as shown in FIG. 7, the first clutch 45 includes a plurality of centrifugal elements 454, a plurality of engaged grooves 455, and a plurality of magnets 456.

The configuration of the first clutch 45 will be explained in detail as follows. First, the input member 42 is disposed radially outside the output member 43. The engaged grooves 455 are provided on the inner peripheral surface of the input member 42. The engaged grooves 455 face radially inward. The engaged grooves 455 are disposed away from each other at intervals in the circumferential direction. The engaged grooves 455 are configured to be engaged with the centrifugal elements 454, respectively.

Each engaged groove 455 is defined in part by a pair of inner wall surfaces 455a and 455b that slant radially inward to gradually separate from each other. The inner wall surfaces 455a and 455b are opposed to each other in the circumferential direction. It should be noted that one or both of the pair of inner wall surfaces 455a and 455b may slant.

The output member 43 includes a plurality of accommodation portions 431. The accommodation portions 431 are opened radially outward. In other words, the accommodation portions 431 are provided on the outer peripheral surface of the output member 43. The accommodation portions 431 are spaced apart from each other at intervals in the circumferential direction. Preferably, the interval between each adjacent pair of accommodation portions 431 is identical to that between each adjacent pair of engaged grooves 455.

The centrifugal elements 454 are accommodated in the accommodation portions 431, respectively. The centrifugal elements 454 are rotated unitarily with the output member 43. Additionally, each centrifugal element 454 is radially movable within each accommodation portion 431. Each centrifugal element 454 is magnetized.

Each centrifugal element 454 includes a pair of lateral surfaces 454a and 454b facing in the circumferential direction. When each centrifugal element 454 is moved radially outward and is engaged with each engaged groove 455, the pair of lateral surfaces 454a and 454b is opposed in part to the pair of inner wall surfaces 455a and 455b. The portions of the pair of lateral surfaces 45a and 45b, opposed to the pair of inner wall surfaces 455a and 455b, slants along the pair of inner wall surfaces 455a and 455b.

The magnets 456 are disposed radially inside the centrifugal elements 454, respectively. The magnets 456 are attached to the output member 43. The magnets 456 are disposed radially inside the accommodation portions 431, respectively. For example, the magnets 456 may be embedded in the output member 43. Each magnet 456 is configured to attract each centrifugal element 454 by a magnetic force.

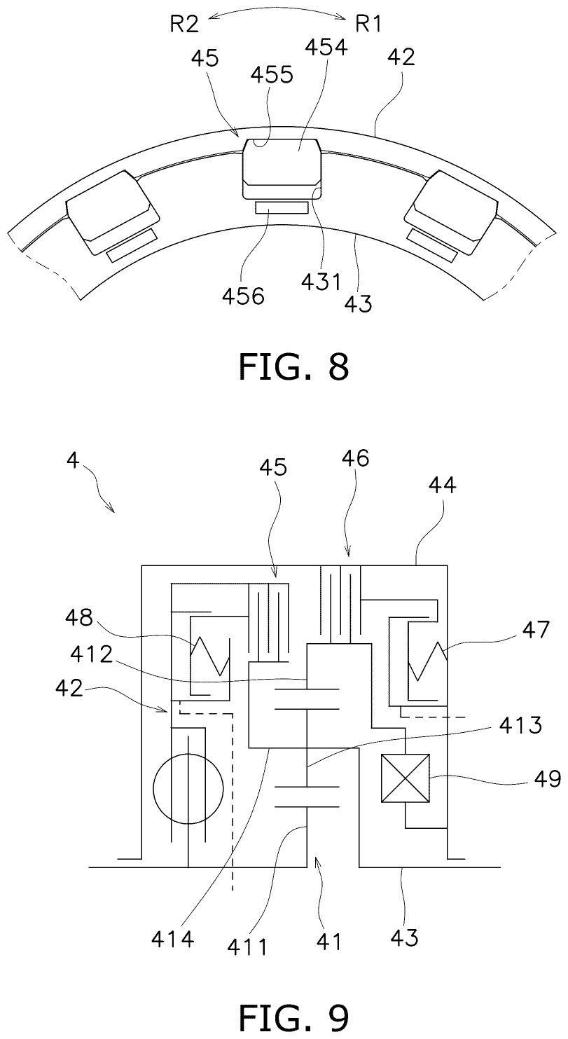

According to the first clutch 45 configured as described above, when the output member 43 is rotated at a speed of greater than a predetermined value, as shown in FIG. 8, the centrifugal elements 454 are moved radially outward by the centrifugal forces and are engaged with the engaged grooves 455, respectively. As a result, the input member 42 and the output member 43 are rotated unitarily with each other.

By contrast, when the output member 43 is rotated at a speed of less than or equal to the predetermined value, as shown in FIG. 7, each centrifugal element 454 is moved radially inward not only by the slant of the pair of inner wall surfaces 455a and 455b but also by the magnetic force of each magnet 456, whereby each centrifugal element 454 and each engaged groove 455 are disengaged from each other. As a result, the input member 42 and the output member 43 are made rotatable relative to each other.

(c) As shown in FIG. 9, the input member 42 may be coupled to the sun gear 411. In that case, the second clutch 46 couples the ring gear 412 and the stationary housing 44 therethrough to each other in a manner capable of decoupling the ring gear 412 and the stationary housing 44 therethrough from each other. Additionally, the one-way clutch 49 is configured to allow the ring gear 412 to rotate in the forward moving rotational direction.

### LIST OF REFERENCE NUMERALS

2: Electric motor, 4: Transmission device, 41: Planetary gear mechanism, 411: Sun gear, 412: Ring gear, 413: Planet gear, 414: Planet carrier, 42: Input member, 421: First input portion, 422: Second input portion, 423: Elastic member, 43: Output member, 44: Stationary housing, 45: First clutch, 454: Centrifugal element, 455: Engaged groove, 455a: Inner wall surface, 455b: Inner wall surface, 456: Magnet, 46: Second clutch, 47: First urging member, 48: Second urging member, 49: One-way clutch, 5: Controller, 100: Drive unit

1. A drive unit, comprising:
an electric motor;
a planetary gear mechanism including a sun gear, a planet gear, a ring gear, and a planet carrier;
an input member coupling the electric motor and one of the ring gear and the sun gear therethrough to each other;
an output member coupled to the planet carrier;
a first clutch coupling the input member and the output member therethrough to each other in a manner capable of decoupling the input member and the output member therethrough from each other;
a stationary member disposed to be non-rotatable;
a second clutch coupling the stationary member and the other of the ring gear and the sun gear therethrough to each other in a manner capable of decoupling the stationary member and the other of the ring gear and the sun gear therethrough from each other; and
a first urging member urging the second clutch to turn the second clutch to an engaged state.

2. The drive unit according to claim 1, further comprising a one-way clutch allowing the other of the ring gear and the sun gear to rotate in a forward moving rotational direction.

3. The drive unit according to claim 1, further comprising a second urging member urging the first clutch to turn the first clutch to a disengaged state.

4. The drive unit according to claim 1, wherein the first clutch is a centrifugal clutch.

5. The drive unit according to claim 4, wherein
the input member is disposed radially outside the output member, and
the first clutch includes
a centrifugal element rotated unitarily with the output member, the centrifugal element disposed to be radially movable with respect to the output member, and
an engaged groove provided on an inner peripheral surface of the input member, the engaged groove configured to be engaged with the centrifugal element.

6. The drive unit according to claim 5, wherein the first clutch further includes a magnet disposed radially inside the centrifugal element, the magnet attracting the centrifugal element by a magnetic force.

7. The drive unit according to claim 5, wherein
the engaged groove includes a pair of inner wall surfaces circumferentially opposed to each other, and
at least one of the pair of inner wall surfaces slants radially inward to gradually separate from the other of the pair of inner wall surfaces.

8. The drive unit according to claim 1, wherein the input member includes a first input portion, a second input portion, and an elastic member elastically coupling the first input portion and the second input portion therethrough to each other.

9. The drive unit according to claim 1, further comprising a controller executing a low-speed forward traveling mode, a high-speed forward traveling mode, and a rearward traveling mode,
wherein the controller causes the electric motor to rotate in a forward moving rotational direction, turns the first clutch to a disengaged state, and turns the second clutch to the engaged state when executing the low-speed forward traveling mode,
the controller causes the electric motor to rotate in the forward moving rotational direction, turns the first clutch to the engaged state, and turns the second clutch to the disengaged state when executing the high-speed forward traveling mode, and
the controller causes the electric motor to rotate in a rearward moving rotational direction, turns the first clutch to the disengaged state, and turns the second clutch to the engaged state when executing the rearward traveling mode.

10. The drive unit according to claim 9, wherein the controller is configured to turn the second clutch to the disengaged state and thereafter turn the first clutch to the engaged state in switching from the low-speed forward traveling mode to the high-speed forward traveling mode.

11. A transmission device configured to change a rotational speed of a mechanical power transmitted thereto from an electric motor, the transmission device comprising:
a planetary gear mechanism including a sun gear, a planet gear, a ring gear, and a planet carrier;
an input member coupling the electric motor and one of the ring gear and the sun gear therethrough to each other;
an output member coupled to the planet carrier;
a first clutch coupling the input member and the output member therethrough to each other in a manner capable of decoupling the input member and the output member therethrough from each other;
a stationary member disposed to be non-rotatable;
a second clutch coupling the stationary member and the other of the ring gear and the sun gear therethrough to each other in a manner capable of decoupling the stationary member and the other of the ring gear and the sun gear therethrough from each other; and
a first urging member urging the second clutch to turn the second clutch to an engaged state.
